(19) United States
(12) Patent Application Publication
(10) Pub. No.: US 2016/0306105 A1
(43) Pub. Date: Oct. 20, 2016

(54) BACKLIGHT AND DISPLAY DEVICE

(71) Applicant: Mitsubishi Electric Corporation, Tokyo (JP)

(72) Inventor: Kenji ARITA, Tokyo (JP)

(73) Assignee: Mitsubishi Electric Corporation, Tokyo (JP)

(21) Appl. No.: 15/051,007

(22) Filed: Feb. 23, 2016

(30) Foreign Application Priority Data
Apr. 17, 2015 (JP) 2015-084867

(51) Int. Cl. F21V 8/00

(52) U.S. Cl. CPC G02B 6/0088; G02B 6/0055

(57) ABSTRACT

A backlight includes an optical sheet and a pressing portion. The pressing portion has a holding portion that holds a projection by coming into contact with the projection of the extended optical sheet when the optical sheet is extended.

### BACKGROUND OF THE INVENTION

1. Field of the Invention

The present invention relates to a backlight having a structure relating to an optical sheet, and a display device.

2. Description of the Background Art

With recent spread of information electronic equipment, a thin, lightweight display device using a backlight has been used in various fields. For example, the display device is used as a display of a portable telephone, a display for a personal computer, a display of each of various devices used for industrial applications, an indicator for vehicle, a display of a handy terminal, an advertisement display, or the like.

Moreover, due to spreading of the fields where the display device is used, the display device is more often used under a harsh environment. For example, cases where the display device is used as a display of a device that vibrates have been increased. The device that vibrates is, for example, construction machinery in which stronger vibration than that of a display for vehicle is caused, amusement equipment that performs production to give an impact, or the like.

However, when the display device vibrates, an optical sheet that the display device includes may be moved. When the optical sheet is moved, there arises a problem that the optical sheet is damaged and quality of video displayed by the display device is deteriorated.

As measures of the problem, for example, there is a method of fixing the optical sheet, using an adhesive material or the like. However, when the display device is used under a harsh environment, adhesion of the adhesive material is lowered by deterioration over time. Thus, due to the lowering of the adhesion, the optical sheet may be peeled. Accordingly, the method of fixing the optical sheet, using the adhesive material is unreliable. Moreover, the use of the adhesive material causes an increase in cost.

In Japanese Patent Application Laid-Open No. 2011-029045, there is disclosed a technique of fixing a film-like optical member (an optical sheet) without using an adhesive material (hereinafter, referred to as a “related art A” as well). Specifically, in the related art A, an optical member supporting surface as an inclined surface is formed in a light guiding member. Moreover, an optical member supporting surface opposed to the optical member supporting surface of the light guiding member is formed in a frame holding the light guiding member. In this configuration, the optical member supporting surface of the light guiding member and the optical member supporting surface of the fame sandwich a peripheral portion (an extension portion) of the optical member, by which the optical member (the optical sheet) is fixed.

Generally, the optical sheet may be extended due to change in temperature around the optical sheet. Thus, it is required that even when the optical sheet is extended, the optical sheet is stably held. In the above-described related art A, this requirement cannot be satisfied.

### SUMMARY OF THE INVENTION

An object of the present invention is to provide a backlight or the like that can stably hold an optical sheet even when the optical sheet is extended.

A backlight according to one aspect of the present invention includes a light source that emits light, an optical sheet that transmits the light emitted by the light source, a housing that holds the optical sheet, and a pressing portion, wherein the optical sheet has a projection, the pressing portion is provided so as to deform the projection of the optical sheet by at least a part of the pressing portion coming into contact with the projection, and the pressing portion has a holding portion that holds the projection by coming into contact with the projection of the extended optical sheet when the optical sheet is extended.

According to the present invention, the backlight includes the optical sheet and the pressing portion. The pressing portion has the holding portion that holds the projection by coming into contact with the projection of the extended optical sheet when the optical sheet is extended.

This allows the projection to be held by the holding portion when the optical sheet is extended. Thus, even when the optical sheet is extended, the optical sheet can be stably held.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a display device according to a first preferred embodiment of the present invention;

FIG. 2 is a perspective view of a backlight according to the first preferred embodiment of the present invention;

FIG. 3 is an enlarged view of a part of the backlight according to the first preferred embodiment of the present invention;

FIG. 4 is an enlarged view of another part of the backlight according to the first preferred embodiment of the present invention;

FIG. 5 is a view for describing a configuration of an optical sheet according to the first preferred embodiment of the present invention;

FIG. 6 is a view for describing a characteristic configuration of a housing;

FIG. 7 is a cross-sectional view of a part of the backlight according to the first preferred embodiment of the present invention;

FIG. 8 is a view for describing a holding portion of a pressing portion;

FIG. 9 is a view showing a configuration of a no-projection region;

FIG. 10 is a view for describing a configuration of an optical sheet according to a modification of the first preferred embodiment of the present invention; and

FIG. 11 is a cross-sectional view of a part of a backlight included in a display device according to a second preferred embodiment of the present invention.

### DESCRIPTION OF THE PREFERRED EMBODIMENTS

Hereinafter, preferred embodiments of the present invention will be described, based on the figures. In the following description, the same components are given the same reference numerals. The same applies to names and function thereof. Accordingly, detailed descriptions thereof may be omitted.

Note that dimensions, materials, shapes, and relational dispositions and the like of the respective components exemplified in the preferred embodiments are changed as needed, depending on a configuration of a device to which the present invention is applied, and various respective conditions. The present invention is not limited to the exemplification thereof. Moreover, dimensions of the respective components in the respective figures may be different from actual dimensions.

### First Preferred Embodiment

### Configuration of Whole Display Device

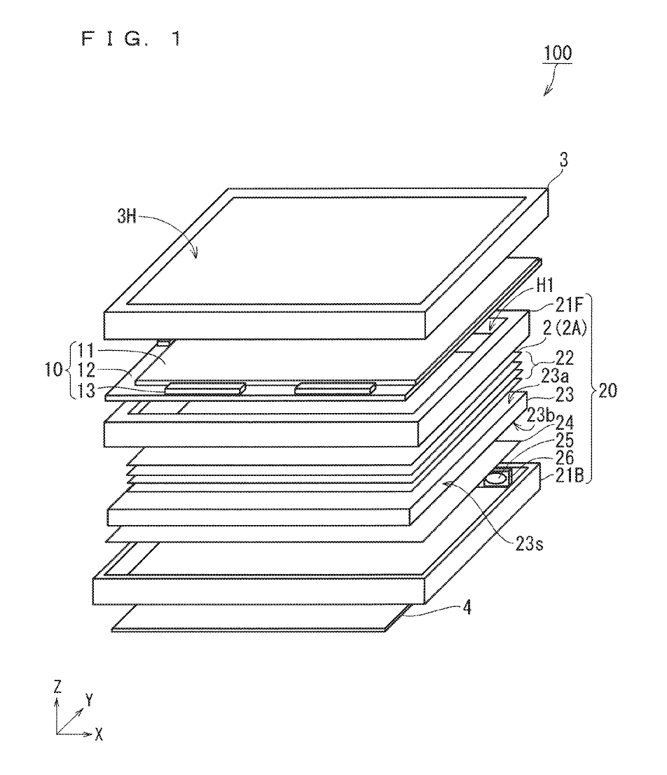

FIG. 1 is an exploded perspective view of a display device 100 according to a first preferred embodiment of the present invention. A display device 100 is, for example, a liquid crystal display device that displays video, using a liquid crystal. Note that the display device 100 is not limited to the liquid crystal display device, but may be a display device in another method. The display device 100 may be, for example, an organic EL (Electroluminescence) display.

In FIG. 1, an X direction, a Y direction, and a Z direction are perpendicular to one another, respectively. An X direction, a Y direction, and a Z direction in each of the following figures are also perpendicular to one another, respectively. In the following, a direction including the X direction and a direction opposite to the X direction (a −X direction) is referred to as an “X axis direction” as well. Moreover, in the following, a direction including the Y direction and a direction opposite to the Y direction (a −Y direction) is referred to as a “Y axis direction” as well. Moreover, in the following, a direction including the Z direction and a direction opposite to the Z direction (a −Z direction) is referred to as a “Z axis direction” as well.

Moreover, in the following, a plane including the X axis direction and the Y axis direction is referred to as an “XY surface” as well. Moreover, in the following, a plane including the X axis direction and the Z axis direction is referred to as an “XZ surface” as well. Moreover, in the following, a plane including the Y axis direction and the Z axis direction is referred to as a “YZ surface” as well.

Referring to FIG. 1, the display device 100 includes a display panel 10, a backlight 20, a housing 3, and a circuit board 4. Note that the display device 100 displays video, using light emitted by the backlight 20, details of which will be described later.

The backlight 20 is a device that emits the light. The backlight 20 irradiates a back surface of the display panel 10 with the light. Inside the housing 3, the display panel 10 and the backlight 20 are disposed. The housing 3 has an opening 3H. Note that in FIG. 1, for simplification of the figure, description of a part of the display panel 10 that is seen through the opening 3H is omitted.

The display panel 10 is, for example, a liquid crystal panel. The display panel 10 displays video. Note that in the display panel 10, on a side of a surface where the video is displayed, a touch panel (not shown) is provided. The touch panel is a panel to accept touch operation by a user. The touch operation is operation of touching the touch panel by the user. The touch panel receives a position signal indicating a position that the user touches in the touch panel.

Moreover, on a surface of the touch panel, a transparent protection member is provided. The protection member is a plate that protects the touch panel. The protection member is provided on the side of the surface of the display panel 10 where the video is displayed. Note that on a surface of the circuit board 4, a cover to protect the circuit board 4 may be provided.

Next, the above-described respective members constituting the display device 100 will be described in more detail.

(Display Panel)

The display panel 10 is a transmission type or semitransmission type liquid crystal panel. The display panel 10 displays the video by applying birefringence of the liquid crystal. The display panel 10 includes a substrate 11, a substrate 12, and ICs (integrated Circuits) for driving 13.

The substrate 11 is a substrate in which a color filter, a light shielding layer, a counter electrode and the like are formed on an insulating substrate such as glass. The substrate 12 is a substrate in which pixel electrodes or the like each using a switching element are formed in matrix on an insulating substrate such as glass. The switching element is a thin film transistor. Hereinafter, the thin film transistor is simply referred to as a “TFT” as well.

The ICs for driving 13 are disposed on a peripheral portion of the substrate 12, or on a tape-like wiring material connected to the peripheral portion of the substrate 12. The wiring material is TCP, COF or the like.

Moreover, in the display panel 10, a spacer, a seal material, the liquid crystal, a sealing material, an alignment film, polarizing plates and the like, which are not shown, are provided. The spacer holds an interval between the substrate 11 and the substrate 12. The seal material sticks the substrate 11 and the substrate 12. The liquid crystal is provided between the substrate 11 and the substrate 12. The sealing material is a member that seals the liquid crystal. The sealing material is provided with an inlet from which the liquid crystal is injected. The alignment film is a film that aligns the liquid crystal. The polarizing plates are disposed on outer surfaces of the substrate 11 and the substrate 12.

(Backlight)

The backlight 20 irradiates the light to the display panel 10 from a side of the substrate 12. The backlight 20 includes a light source 25, a light guiding plate 23, an optical sheet portion 22, a reflecting sheet 24, a housing 21F, and a housing 21B.

The light source 25 emits the light. The light guiding plate 23 guides the light emitted by the light source 25 to a specific direction. More specifically, the light guiding plate 23 is a member to guide the light to the optical sheet portion 22. Specifically, the light guiding plate 23 has an outgoing surface 23a, a counter-outgoing surface 23b, and side surfaces 23s. The outgoing surface 23a is a surface from which the light is emitted. The counter-outgoing surface 23b is a surface opposite to the outgoing surface 23a in the light guiding plate 23. On the counter-outgoing surface 23b, the reflecting sheet 24 is provided.

The light emitted by the light source 25 is propagated to an inside of the light guiding plate 23 through the side surfaces 23s of the light guiding plate 23. The light propagated to the inside of the light guiding plate 23 is emitted from the outgoing surface 23a in the Z direction. That is, the light guiding plate 23 emits the light emitted by the light source 25 from the outgoing surface 23a. Note that the display panel 10 is provided on a side of the outgoing surface 23a of the light guiding plate 23.

The optical sheet portion 22 is provided on the outgoing surface 23a of the light guiding plate 23. The optical sheet portion 22 is configured by a plurality of optical sheets 2. Note that the optical sheet portion 22 may be configured by one optical sheet 2. That is, the optical sheet portion 22 is configured by one or more optical sheets 2. The optical sheets 2 each transmit the light emitted by the outgoing surface 23a (the light source 25) and used for the display of the video. The optical sheets 2 extend in a direction along the XY surface.

Note that each of the optical sheets 2 is a sheet that extends in accordance with change in a state of air around the optical sheet 2. Specifically, the optical sheet 2 extends in accordance with change in temperature of the air around the optical sheet 2. For example, when the temperature of the air around the optical sheet 2 becomes high, the optical sheet 2 extends. Herein, the high temperature is, for example, 40 degrees or more.

Moreover, the optical sheet portion 22 controls distribution and spread of the light emitted from the light guiding plate 23. The optical sheet portion 22 emits the light emitted from the outgoing surface 23a to the display panel 10. The display panel 10 uses the light emitted from the outgoing surface 23a to display the video.

The reflecting sheet 24 is provided on a side of the counter-outgoing surface 23b in the light guiding plate 23. The counter-outgoing sheet 24 is a sheet to reflect the light. The existence of the reflecting sheet 24 allows the light emitted from the light guiding plate 23 in the −Z direction to be reflected at the reflecting sheet 24 and enter the light guiding plate 23 again.

The light source 25, the light guiding plate 23, the optical sheet portion 22, and the reflecting sheet 24 are contained in the housing 21B. Note that the reflecting sheet 24 is provided in a bottom surface of the housing 21B. The light guiding plate 23 is provided on the reflecting sheet 24. This allows a position in the Z axis direction of the light guiding plate 23 to be fixed by the bottom surface of the housing 21B and the reflecting sheet 24.

The housing 21B is a back surface housing provided on a back surface side of the backlight 20. The housing 21F is provided so as to cover the optical sheet portion 22. That is, the housing 21F holds the respective optical sheets 2 constituting the optical sheet portion 22. The housing 21F is a front surface housing provided on a front surface side of the backlight 20.

The light source 25 is a point light source that emits white light. The light source 25 is an LED (Light Emitting Diode), a laser diode, or the like. Note that the light source 25 may be a light source that emits red light (R), green light (G), and blue light (B). Moreover, the light source 25 may be a light source that emits light in a color other than RGB.

The light source 25 is mounted on a light source substrate 26. The light source substrate 26 is a substrate made of a general glass epoxy resin as a base, a substrate using a flexible flat cable, or the like. Note that in order to increase heat dissipation, the light source substrate 26 may be a substrate made of metal (e.g., aluminum or the like), ceramic or the like as a base.

Note that the light source 25 is not limited to the point light source mounted on the light source substrate 26, but may be configured by a linear light source such as a fluorescent lamp.

The light guiding plate 23 is made of a transparent acryl resin, a polycarbonate resin, glass or the like. Both or one of the outgoing surface 23a and the outgoing surface 23b of the light guiding plate 23 are (is) formed with a dot pattern for scattering, a prism shape portion or the like. The dot pattern for scattering, the prism shape portion or the like is to emit the light and to adjust intensity distribution of the light inside the surface and an emission direction of the light.

Moreover, in order to adjust the intensity distribution of the light and an emission angle of the light, the optical sheet portion 22 is disposed on the light guiding plate 23. The optical sheet portion 22 is configured by the plurality of optical sheets 2, as described before.

The optical sheet portion 22 is configured by disposing the necessary number of lens sheets, diffusion sheets, viewing angle adjustment sheets and the like. The lens sheet is a sheet to perform light condensing. The diffusion sheet is a sheet to uniformize the light. The viewing angle adjustment sheet is a sheet to adjust luminance in a direction of a viewing angle. That is, each of the optical sheets 2 constituting the optical sheet portion 22 is any of the lens sheet, the diffusion sheet, the viewing angle adjustment sheet and the like. Note that the optical sheet portion 22 may be configured by one optical sheet 2, as described before.

The housing 21F has an opening H1. The opening H1 is a channel of the light emitted from the outgoing surface 23a of the light guiding plate 23. In a periphery of an upper surface of the housing 21F, the display panel 10 is mounted and positioned. This allows the display panel 10 to be held by the housing 21F. A material making the housing 21F is metal such as aluminum, stainless steel, and iron, a resin material such as PC (polycarbonate), and ABS (acrylonitrile butadiene styrene), and the like.

A shape of the housing 21F in planar view (the XY surface) is a frame shape. Moreover, a shape of an outline of the housing 21F in planar view (the XY surface) is rectangular.

In the housing 21B, the light source 25 and the light source substrate 26 are positioned. That is, the housing 21B holds the light source 25 and the light source substrate 26. In order to conduct heat dissipated from the light source 25, it is desirable to use metal having a high heat conductivity. Therefore, the housing 21B is made of aluminum or an aluminum alloy, which has a high heat conductivity. With this configuration, the housing 21B can efficiently diffuse the heat from the light source 25, and a temperature of the light source 25 can be decreased. This can prevent heat from being accumulated in the backlight 20.

The housing 21F and the housing 21B are generally fixed to each other by a hook structure with a claw, screw fastening or the like. Thereby, the housing 21F and the housing 21B hold the optical sheet portion 22, the light guiding plate 23, the reflecting sheet 24 and the like. Note that the housing 21F and the housing 21B may be integrally formed.

(Housing)

The housing 3 is a frame-like member. The housing 3 holds the display panel 10, the backlight 20, the touch panel (not shown), the protection member (not shown) and the like. The housing 3 is formed by a thin plate of a metal, a resin molded article or the like. The housing 3 is fixed to the housing 21B of the backlight by a claw-like fixing structure, screw fastening, or the like. The claw-like fixing structure is a structure in which claw-like projected portions provided respectively in the housing 3 and the housing 21B are engaged with each other.

The housing 3 may be formed integrally, or may be formed by combining a plurality of members. Moreover, an attachment portion (a screw, an attachment hole and the like) to an end product may be provided in a side surface, a front surface, a back surface, a peripheral portion or the like of the housing 3.

(Circuit Board)

The circuit board 4 controls the display panel 10 and the light source 25 by an electrical input/output signal. The circuit board 4 is typically configured by forming a copper pattern on glass epoxy or the like, and mounting an electronic component on a surface of the glass epoxy by soldering. The circuit board 4 is mainly disposed (fixed) on the back surface side (the side from which the light is not emitted) of the backlight 20.

Note that the circuit board 4 may be configured by mounting the electronic component on FPC (Flexible Printed Circuits). The FPC is obtained by forming wiring in a base material on a film connected to the display panel 10.

Moreover, in order to protect the circuit board 4 from external pressure or static electricity, a protection cover (not shown) may be attached to the circuit board 4. The protection cover is made of metal such as aluminum, stainless steel, and a galvanized steel sheet, a film-like thin resin such as PET (PolyEthylene Terephthalate) or the like.

Note that when the metal protection cover is used, a sheet made of a resin such as PET is stuck to the circuit board 4 in order to avoid electrical contact between the circuit board 4 and the electronic component on the circuit board 4. Thereby, insulating measures can be taken.

(Touch Panel)

The touch panel (not shown) is configured by a transparent substrate and a circuit by a transparent electrode formed on the transparent substrate. The touch panel converts information regarding position coordinates input externally (by the user) to an electric signal by the above-described circuit. Then, the touch panel transmits the electric signal to a control circuit of the end product through an output wiring portion connected to an end portion of the touch panel.

For the output wiring portion, FPC (Flexible Printed Circuits) obtained by forming wiring in a base material on a film are used because of a degree of freedom of connection by thinness and flexibility. Note that the output wiring portion is not limited to the FPC, but may be made of a different material, or may have a different structure, as long as they have equivalent functions and characteristics.

(Protection Member)

The protection member (not shown) is a plate to prevent damage by application of pressure, contact or the like to an input surface of the touch panel, or deformation, abrasion, dirt or the like of the touch panel. The protection member is provided on the side of the surface of the display panel 10 where the video is displayed. The protection member is made of a transparent material such as glass, plastic and the like. Note that a peripheral portion of a front surface or a back surface of the protection member may be subjected to processing by printing for the purpose of light shielding or a design.

(Characteristic Configuration)

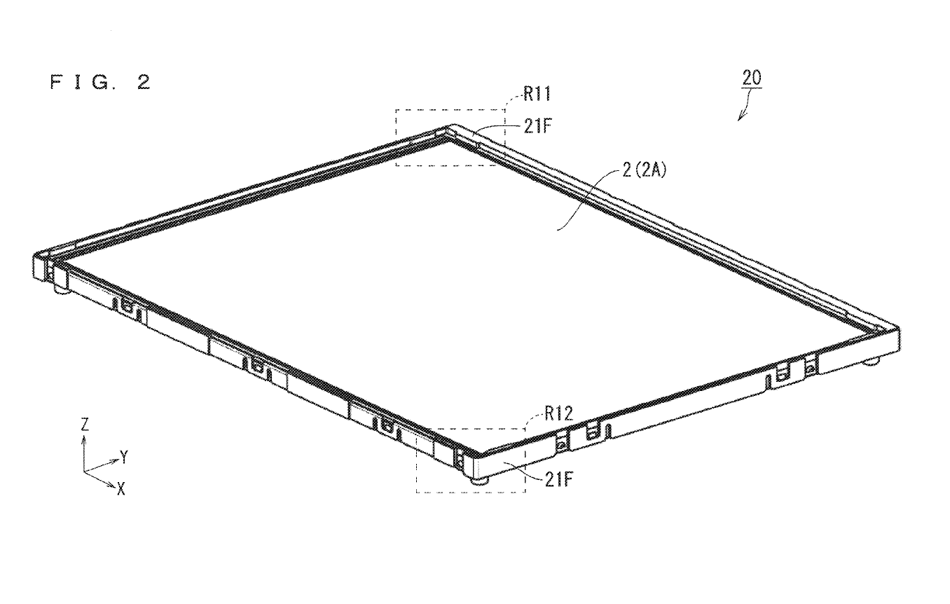

Next, a characteristic configuration in the present preferred embodiment will be described in detail. FIG. 2 is a perspective view of the backlight 20 according to the first preferred embodiment of the present invention. The backlight 20 has a light-emitting region R50 (not shown) described later. The light-emitting region R50 is a region from which the backlight 20 emits the light.

In the following, of the plurality of optical sheets 2 constituting the optical sheet portion 22, the top optical sheet 2 is referred to as an “optical sheet 2A” as well. Moreover, in the following, of the plurality of the optical sheets 2 constituting the optical sheet portion 22, the optical sheets 2 other than the optical sheet 2A are referred to as “lower optical sheets” as well.

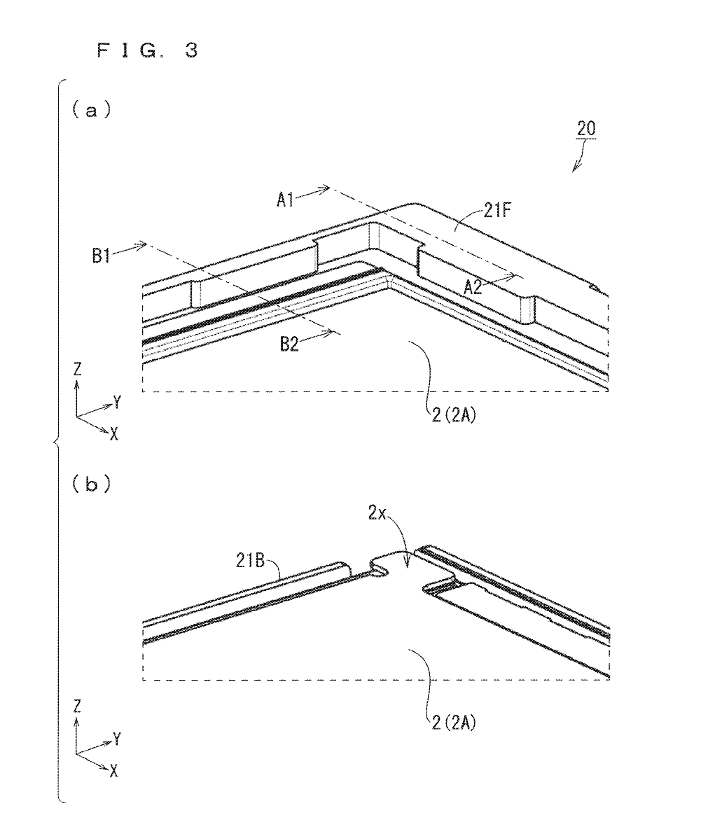

FIG. 3 is an enlarged view of a part of the backlight 20 according to the first preferred embodiment of the present invention. Part (a) in FIG. 3 is an enlarged view of a region R11 in FIG. 2. Part (b) in FIG. 3 is a view in which in order to make a configuration easy to understand, in the configuration in part (a) in FIG. 3, the housing 21F is not shown.

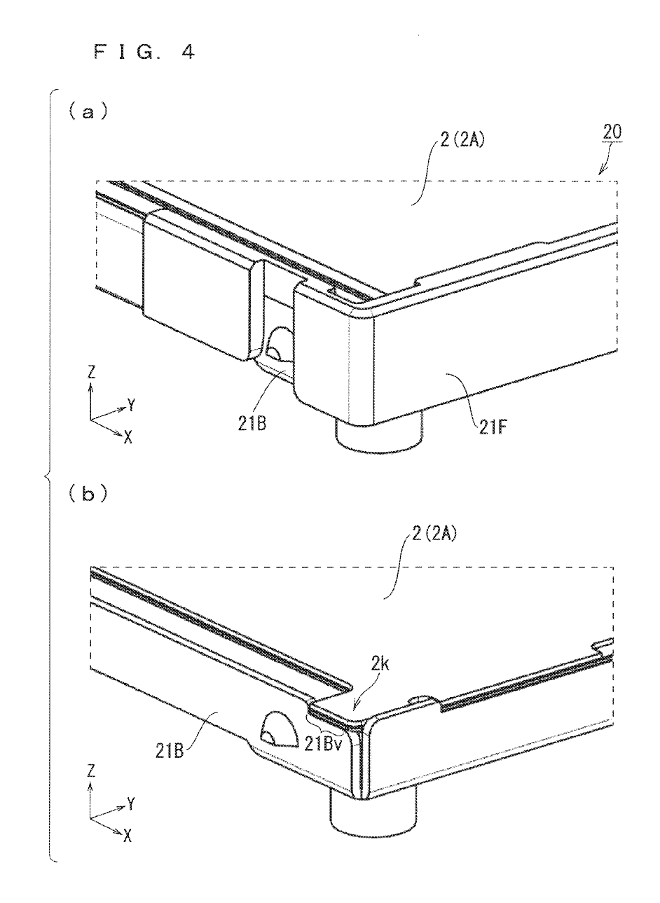

FIG. 4 is an enlarged view of another part of the backlight 20 according to the first preferred embodiment of the present invention. Part (a) in FIG. 4 is an enlarged view of a region R12 in FIG. 2. Part (b) in FIG. 4 is a view in which in order to make a configuration easy to understand, in the configuration in part (a) in FIG. 4, the housing 21F is not shown.

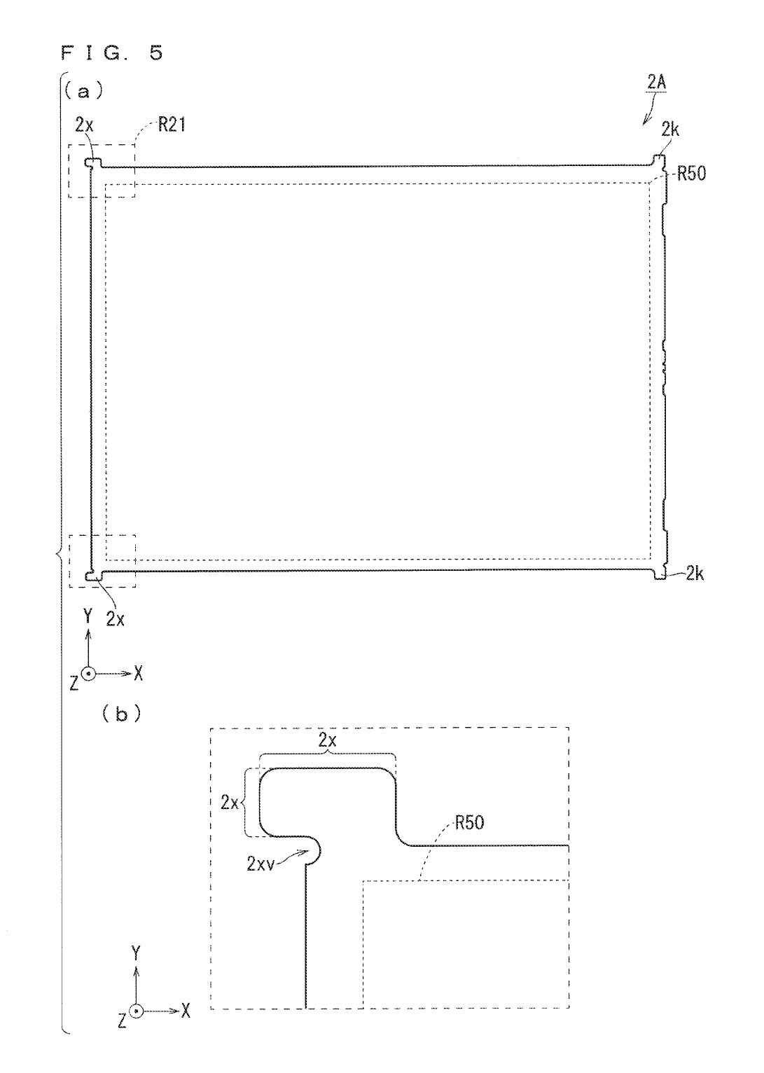

FIG. 5 is a view for describing a configuration of the optical sheet 2A according to the first preferred embodiment of the present invention. Note that FIG. 5 shows the foregoing light-emitting region R50 in the XY surface. In the following, in the optical sheet 2A, a region other than the light-emitting region R50 is referred to as a “sheet peripheral region” as well. Part (a) in FIG. 5 is a plan view of the optical sheet 2A. Part (b) in FIG. 5 is an enlarged view of a region R21 in part (a) in FIG. 5.

First, the optical sheet 2A will be described. Referring to FIG. 5, the optical sheet 2A has projections 2x. The projections 2x are each provided so as to project in a direction where the optical sheet 2A extends and in a direction around the optical sheet 2A. The direction in which the optical sheet 2A extends is a direction along the XY surface (a main surface of the optical sheet 2A).

Moreover, a shape of the optical sheet 2A in planar view (the XY surface) is substantially rectangular. As shown in part (a) in FIG. 5, the projections 2x are provided at respective left corner portions of the optical sheet 2A in planar view (the XY surface).

Note that in order to make the projections 2x easy to deform in the Z axis direction, a cutout 2xv is provided at a base of each of the projections 2x. This enables the projection 2x to be easily deformed. A depth of the cutout 2xv is adjusted, by which flexibility of the projection 2x can be adjusted.

Moreover, the optical sheet 2A has engagement portions 2k. The engagement portions 2k are provided so as to engage with the housing 21B, details of which will be described later. As shown in part (a) in FIG. 5, the engagement portions 2k are provided at respective right corner portions of the optical sheet 2A in planar view (the XY surface). Note that in the housing 21B, cutouts 21Bv to engage with the engagement portions 2k are provided as shown in part (b) in FIG. 4.

Moreover, a shape of the housing 21B in planar view (the XY surface) is rectangular. Each of the cutouts 21Bv is provided in a region overlapping with a region where each of the engagement portions 2k of the optical sheet 2A is provided in planar view (the XY surface). Specifically, the cutouts 21Bv are provided at respective right corner portions of the housing 21B in planar view (the XY surface).

In the following, a portion provided in each of the cutouts 21Bv in the housing 21B is referred to as a “cutout formation portion” as well. The optical sheet 2A is provided so that the engagement portions 2k are engaged with the cutout formation portions of the housing 21B, as shown in part (b) in FIG. 4. The engagement portions 2k of the optical sheet 2A are engaged with the cutout formation portions, by which the optical sheet 2A is positioned.

Note that positions where the projections 2x and the engagement portions 2k are provided are not limited to the positions shown in part (a) in FIG. 5. The projections 2x may be provided, for example, at the two corner portions having a diagonal relation in the optical sheet 2A in planar view (the XY surface). The projections 2x may be provided, for example, at the upper left corner portion of the optical sheet 2A and the lower right corner portion of the optical sheet 2A in planar view (the XY surface).

The backlight 20 includes pressing portions 21Fx each having a configuration that deforms the projection 2x, details of which will be described later.

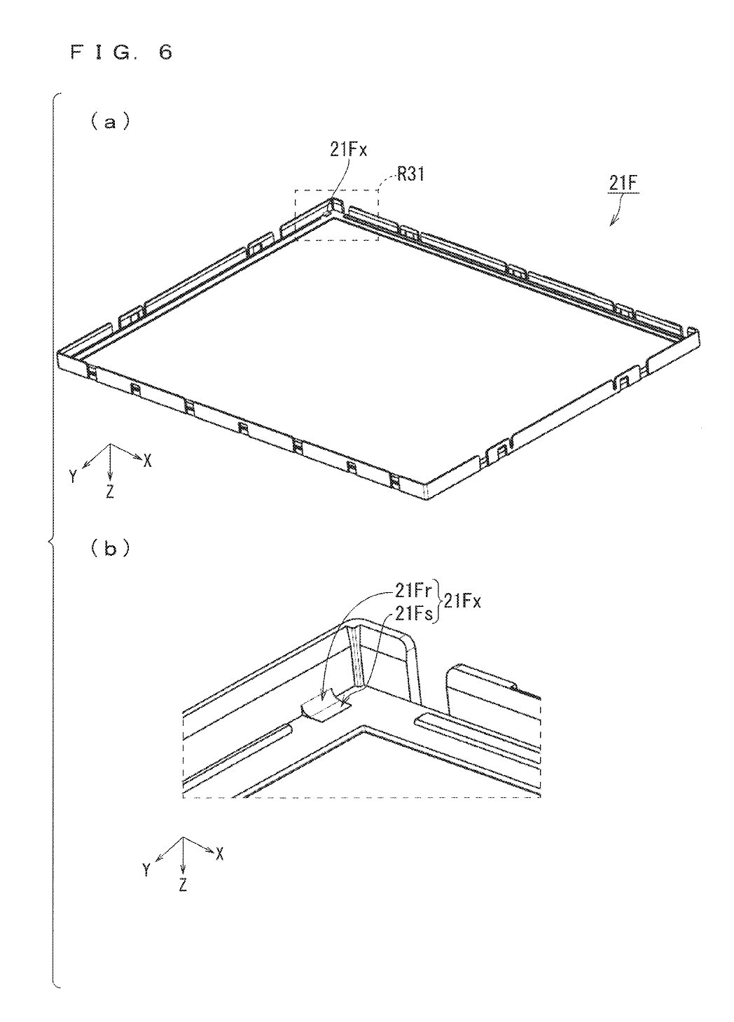

Next, details of a configuration of the housing 21F will be described. FIG. 6 is a view for describing a characteristic configuration of the housing 21F. Part (a) in FIG. 6 is a perspective view of the housing 21F. Specifically, part (a) in FIG. 6 is a perspective view of a configuration on a back side of the housing 21F. Part (b) in FIG. 6 is an enlarged view of a region R31 in part (a) in FIG. 6.

Referring to parts (a) and (b) in FIG. 6, the foregoing pressing portions 21Fx are provided in the housing 21F. As described before, the shape of the outline of the housing 21F in planar view (the XY surface) is rectangular. Specifically, the pressing portions 21Fx are provided at corner portions of the housing 21F in planar view (the XY surface).

Moreover, each of the pressing portions 21Fx is provided in a region overlapping with a region where each of the projections 2x is provided in planar view (the XY surface). That is, each of the pressing portions 21Fx is provided in almost the same region as the region where each of the projections 2x is provided in planar view (the XY surface). Therefore, when the two projections 2x are provided in the optical sheet 2A, as shown in part (a) in FIG. 5, the two pressing portions 21Fx are provided at the two corner portions of the housing 21F, respectively.

Here, the following assumption A1 is considered. On the assumption A1, the optical sheet portion 22 is configured by the three optical sheets 2.

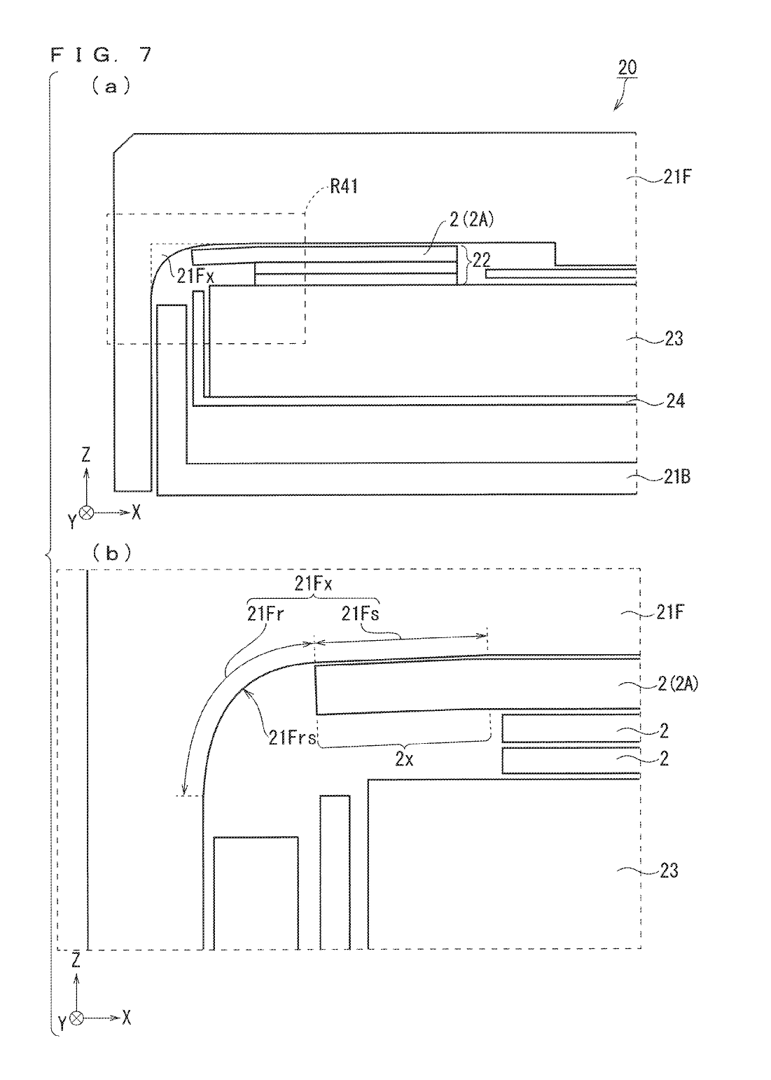

Next, a configuration of the pressing portion 21Fx in the assumption A1 will be described in detail. FIG. 7 is a cross-sectional view of a part of the backlight 20 according to the first preferred embodiment of the present invention. Part (a) in FIG. 7 is a cross-sectional view of the backlight 20 along an A1-A2 line in part (a) in FIG. 3. Part (b) in FIG. 7 is an enlarged view of a region R41 in part (a) in FIG. 7. Note that while in part (b) in FIG. 7, the respective optical sheets 2 are shown at intervals in order to make the configuration easy to understand, the respective optical sheets 2 are actually in contact with one another.

Referring to part (b) in FIG. 6, part (a) in FIG. 7, and part (b) in FIG. 7, the pressing portions 21Fx are provided at the corner portions of the housing 21F, as described before. Moreover, as described before, each of the pressing portions 21Fx is provided in the region overlapping with the region where each of the projections 2x is provided in planar view (the XY surface). In other words, each of the projections 2x is provided in the region overlapping with the region where each of the pressing portions 21Fx is provided in planar view (the XY surface).

The pressing portion 21Fx is provided so as to deform the projection 2x of the optical sheet 2A by at least a part (an inclined portion 21Fs described later) of the pressing portion 21Fx coming into contact with the projection 2x.

Specifically, the pressing portion 21Fx is configured by the inclined portion 21Fs and a holding portion 21Fr. That is, the pressing portion 21Fx has the inclined portion 21Fs and the holding portion 21Fr. The inclined portion 21Fs is provided so as to deform the projection 2x of the optical sheet 2A by coming into contact with the projection 2x in an ordinary temperature environment. In detail, the inclined portion 21Fs is provided so as to slightly bend the projection 2x of the optical sheet 2A in the −Z direction by coming into contact with the projection 2x.

The inclined portion 21Fs is configured such that a surface of the inclined portion 21Fs is inclined with respect to the XY plane. An inclination angle of the surface of the inclined portion 21Fs is two degrees or more as one example. Note that if the inclined portion 21Fs does not exist, the projection 2x and a surface of a portion of the housing 21F opposed to the projection 2x become flat. In this case, a clearance exists between the projection 2x and the housing 21F, which brings about a state where the projection 2x is difficult to come into contact with the housing 21F.

On the other hand, in the present preferred embodiment, the above-described configuration of the inclined portion 21Fs can increase a contact area between the inclined portion 21Fs and the projection 2x, as compared with the configuration in which the inclined portion 21Fs does not exist and the projection 2x is not deformed. This increases friction resistance between the inclined portion 21Fs and the projection 2x. Accordingly, when vibration occurs in the backlight 20 (the display device 100), the optical sheet 2A can be restrained from moving due to the vibration.

Moreover, with the configuration in which the projection 2x of the optical sheet 2A comes into contact with the inclined portion 21Fs, the optical sheet 2A presses the optical sheets 2, which are the lower optical sheets, in the −Z direction by a slight stress. This can restrain the optical sheets 2, which are the lower optical sheets, from moving due to the vibration.

Note that the adjustment of the inclination angle of the surface of the inclined portion 21Fs allows the above-described contact area to be adjusted in accordance with a thickness and a size of the optical sheet 2A.

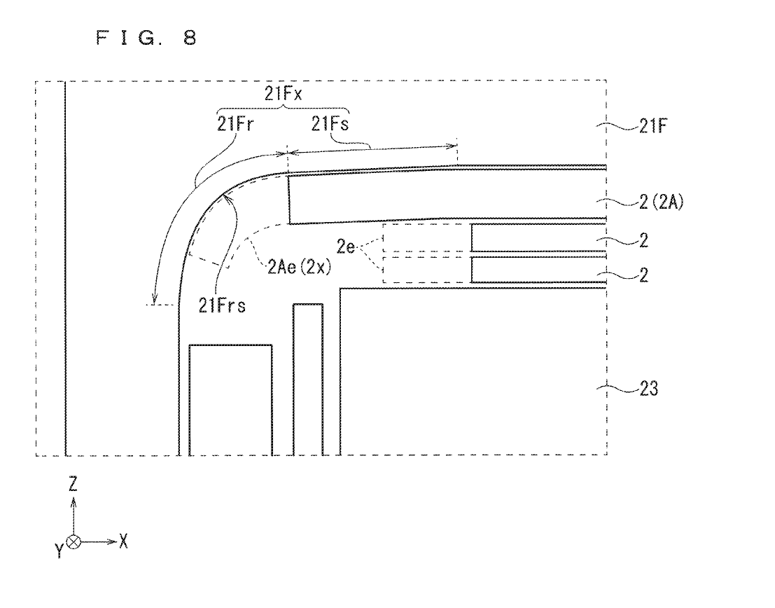

Next, the holding portion 21Fr of the pressing portion 21Fx will be described. FIG. 8 is a view for describing the holding portion 21Fr of the pressing portion 21Fx. Moreover, FIG. 8 is a view showing a state where a shape of a part of the configuration shown in part (b) in FIG. 7 is changed. That is, FIG. 8 shows a configuration of the backlight 20 at the same position as the position where the configuration of part (b) in FIG. 7 is provided.

In the following, air around the optical sheet 2A is referred to as “ambient air” as well. The ambient air is also air around the display device 100. Moreover, in the following, a state where a temperature of the ambient air is high is referred to as a “high-temperature state” as well. The high temperature is, for example, 40 degrees or more, as described before. Moreover, a state where the optical sheet 2A or the optical sheets 2, which are the lower optical sheets, are extended due to the high temperature of the ambient air is referred to as a “sheet extended state” as well.

When the display device 100 is used in a harsh high temperature environment, that is, when the temperature of the ambient air becomes high, the optical sheet 2A and the lower optical sheets (the optical sheets 2) are extended. In FIG. 8, extended portions 2Ae, 2e are shown.

The extended portion 2Ae is an extended portion of the optical sheet 2A when the optical sheet 2A is extended. Note that the extended portion 2Ae is the projection 2x. The extended portions 2e are extended portions of the optical sheets 2, which are the lower optical sheets, when the optical sheets 2 are extended.

The holding portion 21Fr is provided so as to hold the projection 2x by coming into contact with the projection 2x of the extended optical sheet 2A when the optical sheet 2A is extended. Specifically, the holding portion 21Fr is configured so as to curve the extended portion 2Ae into a circular arc shape by the holding portion 21Fr coming into contact with the extended portion 2Ae (the projection 2x) in the sheet extended state.

In the following, a defect attributed to the extension of the optical sheet 2A is referred to as a “defect Df” as well. The holding portion 21Fr can suppress the occurrence of the defect Df. The defect Df is, for example, a defect that a crease occurs in the optical sheet 2A. Moreover, the defect Df is, for example, a defect that the optical sheet 2A (the extended portion 2Ae) is bent at an acute angle.

Specifically, the holding portion 21Fr has a curved surface 21Frs, as shown in part (b) in FIG. 7 and FIG. 8. The curved surface 21Frs is provided so as to curve the extended portion 2Ae into the circular arc by the curved surface 21Frs coming into contact with the extended portion 2Ae (the projection 2x) in the sheet extended state.

The curved surface 21Frs is configured by a moderately curved surface in order to prevent the occurrence of the defect Df. That is, a curvature radius of the curved surface 21Frs is set to a radius that prevents the occurrence of the defect Df. Moreover, a circular arc length of the curved surface 21Frs is set to a length equal to and more than a maximum length that the optical sheet 2A is extended in the high-temperature state.

As described above, the configuration of the holding portion 21Fr enables the optical sheet 2A to be stably held even when the optical sheet 2A is extended.

Next, the region where each of the projections 2x is provided will be described. As described above, the projections 2x (the optical sheet 2A) are held and positioned by the inclined portions 21Fs and the holding portions 21Fr. The projections 2x are thus provided such that the deformed projections 2x do not enter the light-emitting region R50 in planar view (the XY surface).

Specifically, referring to FIG. 5, the projections 2x are provided in the foregoing sheet peripheral region other than the light-emitting region R50 in the optical sheet 2A. This can prevent the deformed projections 2x from entering the light-emitting region R50 by the inclined portions 21Fs, the holding portions 21Fr and the like in planar view (the XY surface). Note that as described before, the display device 100 displays the video, using the light emitted by the backlight 20. Note that if the projections 2x exist inside the light-emitting region R50, part of the light emitted by the backlight 20 is shielded by the projections 2x. In this case, quality of the video displayed by the display device 100 is deteriorated.

Consequently, as described above, the projections 2x are configured so as to be prevented from entering the light-emitting region R50, which can thus prevent the quality of the video displayed by the display device 100 from being deteriorated.

In the following, a region where the projection 2x does not exist in planar view (the XY surface) is referred to as a “no-projection region” as well.

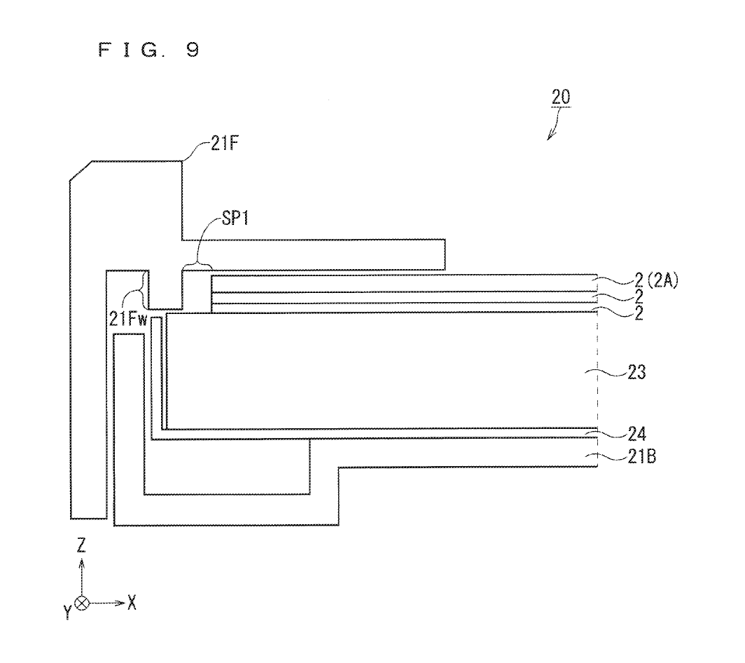

Next, the no-projection region of the display device 100 will be described. The no-projection region of the display device 100 is configured as follows. FIG. 9 is a view showing a configuration of the no-projection region. Moreover, FIG. 9 is a cross-sectional view of the backlight 20 along a B1-B2 line in part (a) in FIG. 3.

Referring to FIG. 9, in the no-projection region, a wall portion 21Fw is provided in the housing 21F. The wall portion 21Fw is provided so that the housing 21F and the wall portion 21Fw contain end portions of the respective optical sheets 2. Moreover, the wall portion 21Fw is provided in the housing 21F so that a space SP1 (clearance) exists between the wall portion 21Fw and the respective optical sheets 2. A size of the space SP1 is set to a size in which the respective optical sheets 2 do not come into contact with the wall portion 21Fw even when the respective optical sheets 2 are extended at the maximum in the high-temperature state.

As described above, according to the present preferred embodiment, the backlight 20 includes the optical sheet 2A and the pressing portions 21Fx. The pressing portions 21Fx each have the holding portion 21Fr that holds the projection 2x by coming into contact with the projection 2x of the extended optical sheet 2A when the optical sheet 2A is extended.

This allows the projections 2x to be held by the holding portions 21Fr when the optical sheet 2A is extended. Thus, even when the optical sheet 2A is extended, the optical sheet 2A can be stably held.

Moreover, according to the present preferred embodiment, the inclined portion 21Fs of the pressing portion 21Fx is provided so as to deform the projection 2x of the optical sheet 2A by coming into contact with the projection 2x. This can increase the contact area between the inclined portion 21Fs and the projection 2x. Accordingly, when vibration occurs in the backlight 20 (the display device 100), the optical sheet 2A can be restrained from moving due to the vibration.

Moreover, according to the present preferred embodiment, the holding portion 21Fr of the pressing portion 21Fx is provided so as to hold the projection 2x by coming into contact with the projection 2x of the extended optical sheet 2A when the optical sheet 2A is extended. Thereby, the holding portion 21Fr can restrain the foregoing defect Df from occurring. The defect Df is, for example, a defect that a crease occurs in the optical sheet 2A. Moreover, the inclined portion 21Fs and the holding portion 21Fr allow the projection 2x (the optical sheet 2A) to be held and positioned.

The display device 100 includes the backlight 20 having the above-described configuration. Therefore, even when the display device is used in a harsh temperature environment, a vibration environment or the like, the quality of the displayed video can be stably maintained, and the optical sheets 2 can be stably held (fixed) and the positioning of the optical sheets 2 can be performed.

Note that while the configuration is employed in which the projections 2x are provided at the two corner portions of the optical sheet 2A, the present invention is not limited thereto. The projections 2x may be provided, for example, at all the four corner portions of the optical sheet 2A in planar view (the XY surface). This can increase accuracy of the positioning of the optical sheet 2A, and allows the housing 21F to securely hold the projections 2x.

Note that an environment where a portable display device, which is smaller than a display device for vehicle or a display device of construction machinery, is used is not harsher than an environment where the display device for vehicle or the display device of the construction machinery is used. Therefore, as to a temperature range in which the portable display device is used and vibration resistance of the portable display device, strict conditions are not required. Accordingly, an expansion/contraction amount of optical sheets used in the portable display device due to change in temperature is very small. Therefore, a crease, deflection or the like is difficult to occur in the optical sheets used in the portable display device.

On the other hand, the display device for vehicle or the display device of the construction machinery or the like is often used under a harsh environment. In this case, in the display device used in the harsh environment, for example, in a high-temperature space, the optical sheets are extended, which causes a crease, deflection or the like to occur in the optical sheets.

Moreover, the small optical sheets used in the small portable display device are thin. Therefore, end portions of the optical sheets can be bent easily. In a medium-sized display device, a large-sized display device or the like, the optical sheets each having a sufficient thickness are used in order to prevent the occurrence of a crease, deflection or the like. Therefore, in the medium-sized display device, the large-sized display device or the like, the optical sheets are fixed in a state deformed by large stress. Accordingly, the optical sheets have a problem that a crease due to temperature change occurs.

Consequently, since the backlight 20 of the present preferred embodiment is configured as described above, the display device 100 including the backlight 20 can solve the above-described problem. That is, even when the display device 100 is used in a harsh temperature environment or a harsh vibration environment, occurrence of a crease attributed to the extension of the optical sheets due to temperature change can be prevented. This can stably maintain the quality of the video displayed by the display device 100.

<Modification of First Preferred Embodiment>

The backlight 20 of the foregoing first preferred embodiment has the following configuration (hereinafter, referred to as a “configuration N1” as well). In the configuration N1, as described before, the projections 2x are provided at the corner portions of the optical sheet 2A in planar view (the XY surface). Moreover, in the configuration N1, as described before, the pressing portions 21Fx are provided at the corner portions of the housing 21F in planar view (the XY surface).

Note that the housing 21F of the backlight 20 may have a shape or a size that makes it difficult to secure spaces for providing the projections 2x at the corner portions of the optical sheet 2A. A configuration of a modification of the present preferred embodiment is a configuration where projections are provided at portions other than the corner portions of the optical sheet 2A (hereinafter, referred to as a “modified configuration A1” as well).

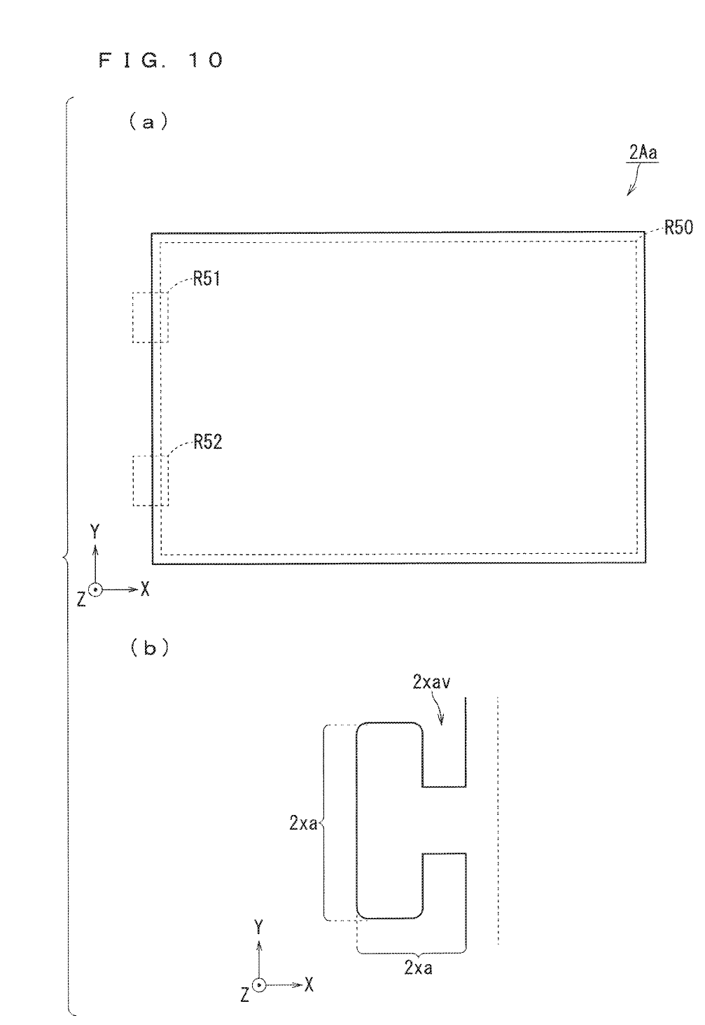

In the following, the optical sheet 2A to which the modified configuration A1 is applied is referred to as an “optical sheet 2Aa” as well. FIG. 10 is a view for describing a configuration of the optical sheet 2Aa according to the modification of the first preferred embodiment of the present invention. Part (a) in FIG. 10 is a plan view of the optical sheet 2Aa. Part (b) in FIG. 10 is an enlarged view of regions R51, R52 in part (a) in FIG. 10.

Referring to part (a) and part (b) in FIG. 10, a shape of the optical sheet 2Aa in planar view (the XY surface) is substantially rectangular. The optical sheet 2Aa has a plurality of projections 2xa. Specifically, on one side (a left side) of the optical sheet 2Aa in planar view (the XY surface), the two projections 2xa are provided. The respective projections 2xa are provided in a central portion of the one side of the optical sheet 2Aa.

A shape of each of the projections 2xa in planar view (the XY surface) is a T-like shape. Thus, cutouts 2xav are provided at a base of each of the projections 2xa. The cutouts 2xav enable the projection 2xa to be easily deformed.

Note that the number of the projections 2xa provided on the one side of the optical sheet 2Aa in planar view (the XY surface) is not limited to two, but one, or three or more may be employed.

Moreover, each of the projections 2xa is provided so as to project in a direction where the optical sheet 2Aa extends, and in a direction around the optical sheet 2Aa. The direction where the optical sheet 2Aa extends is a direction along the XY surface (a main surface of the optical sheet 2Aa).

Moreover, in the housing 21F to which the modified configuration A1 is applied, the pressing portion 21Fx is provided in a region overlapping with a region where each of the projections 2xa is provided in planar view (the XY surface). In other words, the projection 2xa is provided in the region overlapping with the region where the pressing portion 21Fx is provided in planar view (the XY surface). As described before, the shape of the outline of the housing 21F in planar view (the XY surface) is rectangular. Thus, the pressing portions 21Fx are provided on the one side of a rectangle exhibited by the housing 21F in planar view (the XY surface).

In the modified configuration A1 as well, the pressing portion 21Fx is provided so as to deform the projection 2xa of the optical sheet 2Aa by at least a part (the inclined portion 21Fs) of the pressing portion 21Fx coming into contact with the projection 2xa. Moreover, the inclined portion 21Fs is provided so as to deform the projection 2xa of the optical sheet 2Aa by coming into contact with the projection 2xa.

Note that in the optical sheet 2Aa, the engagement portions 2k (not shown) are provided in the same manner as in the optical sheet 2A in FIG. 5. This allows the optical sheet 2Aa to be fixed.

Note that the configuration may be such that the engagement portions 2k are not provided in the optical sheet 2Aa. In this configuration, the projections 2xa are provided in three sides other than the left side of the rectangle exhibited by the optical sheet 2Aa in planar view (the XY surface) in the same manner as in FIG. 10.

As described above, in the modification of the present preferred embodiment as well, the modified configuration A1 brings about the same effect as that of the first preferred embodiment.

### Second Preferred Embodiment

In the first preferred embodiment and the modification of the first preferred embodiment, the pressing portions 21Fx are provided in the housing 21F. The present preferred embodiment has a configuration in which pressing portions are provided in a reflecting sheet (hereinafter, referred to as a “modified configuration B1” as well).

In the following, a backlight to which the modified configuration B1 is applied is referred to as a “backlight 20A” as well. Moreover, in the following, a display device to which the modified configuration B1 is applied is referred to as a “display device 100A” as well.

The display device 100A is different from the display device 100 in FIG. 1 in that the backlight 20A is included in place of the backlight 20. Other configurations of the display device 100A are similar to those of the display device 100, and thus, detailed description will not be repeated.

The backlight 20A is different from the backlight 20 in FIG. 1 in that a reflecting sheet 24A is included in place of the reflecting sheet 24. Other configurations of the backlight 20A are similar to those of the backlight 20, and thus, detailed description will not be repeated.

The reflecting sheet 24A is different from the reflecting sheet 24 only in shape. Other functions of the reflecting sheet 24A are similar to those of the reflection sheet 24, and thus, detailed description will not be repeated. That is, the reflecting sheet 24A is a sheet to reflect light.

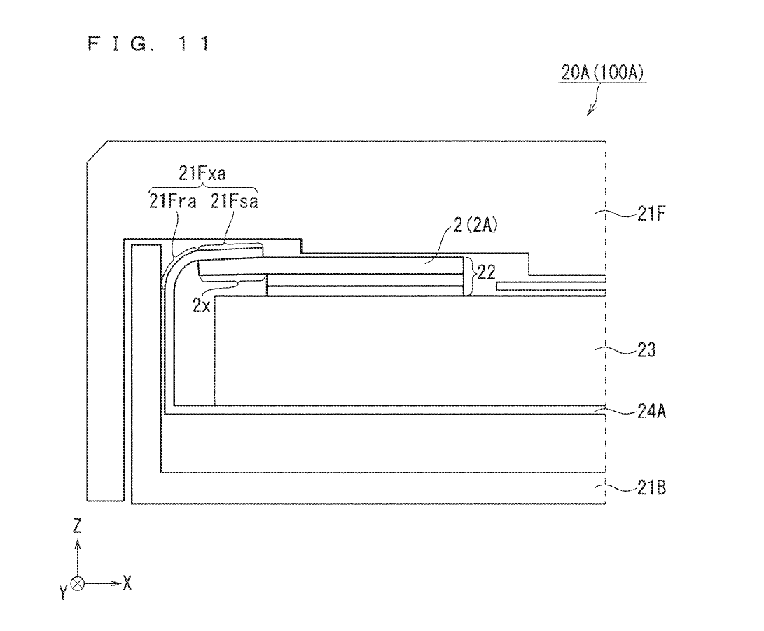

FIG. 11 is a cross-sectional view of a part of the backlight 20A included in the display device 100A according to a second preferred embodiment of the present invention. FIG. 11 shows a configuration of the backlight 20A at the same position as the position where the configuration in part (a) in FIG. 7 is provided. That is, FIG. 11 is a cross-sectional view of the backlight 20A to which the modified configuration B1 is applied along the A1-A2 line in part (a) in FIG. 3.

Referring to FIG. 11, the reflecting sheet 24A has a pressing portion 21Fxa. Specifically, an end portion of the reflecting sheet 24A is bent. The end portion of the reflecting sheet 24A has the pressing portion 21Fxa.

The pressing portion 21Fxa is provided in a region overlapping with a region where a projection 2x is provided in planar view (the XY surface). In other words, the projection 2x is provided in the region overlapping with the region where the pressing portion 21Fxa is provided in planar view (the XY surface).

Moreover, the pressing portion 21Fxa has the same function as that of the pressing portion 21Fx. Specifically, the pressing portion 21Fxa is provided so as to deform the projection 2x of the optical sheet 2A by at least a part (an inclined portion 21Fsa described later) of the pressing portion 21Fxa coming into contact with the projection 2x.

Specifically, the pressing portion 21Fxa is configured by the inclined portion 21Fsa and a holding portion 21Fra. That is, the pressing portion 21Fxa has the inclined portion 21Fsa and the holding portion 21Fra. The inclined portion 21Fsa has the same function as that of the inclined portion 21Fs in part (b) in FIG. 7. That is, the inclined portion 21Fsa is provided so as to deform the projection 2x of the optical sheet 2A by coming into contact with the projection 2x in an ordinary temperature environment.

Moreover, the holding portion 21Fra has the same function as that of the holding portion 21Fr in FIG. 8. That is, the holding portion 21Fra is provided so as to hold the projection 2x by coming into contact with the projection 2x of the extended optical sheet 2A when the optical sheet 2A is extended.

As described above, in the present preferred embodiment as well, the modified configuration B1 brings about the same effect as that in the first preferred embodiment.

Note that in the present invention, in a range of the invention, the respective preferred embodiments and the modifications of the respective preferred embodiments can be combined freely, and the respective preferred embodiments and the modifications of the respective preferred embodiments can be modified or omitted as needed.

For example, a configuration may be employed in which the modified configuration A1 of the modification of the first preferred embodiment is applied to the modified configuration B1 (hereinafter, referred to as a “modified configuration Ab” as well). The backlight 20A to which the modified configuration Ab is applied includes the optical sheet 2Aa in FIG. 10 in place of the optical sheet 2A. That is, the backlight 20A to which the modified configuration Ab is applied includes the optical sheet 2Aa having the projections 2xa. Moreover, the backlight 20A to which the modified configuration Ab is applied includes the reflecting sheet 24A in FIG. 11.

In the modified configuration Ab, the projection 2xa is provided in the region overlapping with the region where the pressing portion 21Fxa is provided in planar view (the XY surface). Note that the shape of the outline of the housing 21F in planar view (the XY surface) is rectangular. Therefore, the pressing portion 21Fxa is provided on one side of the rectangle exhibited by the housing 21F in planar view (the XY surface).

Moreover, in the modified configuration Ab, the pressing portion 21Fxa is provided so as to deform the projection 2xa by at least a part (the inclined portion 21Fsa) of the pressing portion 21Fxa coming into contact with the projection 2xa of the optical sheet 2Aa.

Moreover, in the modified configuration Ab, the holding portion 21Fra is provided so as to hold the projection 2xa by coming into contact with the projection 2xa of the extended optical sheet 2Aa when the optical sheet 2Aa is extended.

In the above-described modified configuration Ab as well, the same effect as that in the first preferred embodiment can be obtained.

While the invention has been shown and described in detail, the foregoing description is in all aspects illustrative and not restrictive. It is therefore understood that numerous modifications and variations can be devised without departing from the scope of the invention.

What is claimed is:

1. A backlight comprising:
a light source that emits light;
an optical sheet that transmits said light emitted by said light source;
a housing that holds said optical sheet; and
a pressing portion,
wherein said optical sheet has a projection,
said pressing portion is provided so as to deform said projection of said optical sheet by at least a part of the pressing portion coming into contact with the projection, and
said pressing portion has a holding portion that holds said projection by coming into contact with the projection of said extended optical sheet when the optical sheet is extended.

2. The backlight according to claim 1, wherein said pressing portion is provided in said housing.

3. The backlight according to claim 2, wherein
a shape of an outline of said housing in planar view is rectangular, and
said pressing portion is provided at a corner portion of said housing in planar view.

4. The backlight according to claim 2, wherein
a shape of an outline of said housing in planar view is rectangular, and
said pressing portion is provided on one side of said rectangle exhibited by said housing in planar view.

5. The backlight according to claim 1 further comprising a reflecting sheet that has said pressing portion and is to reflect light.

6. The backlight according to claim 1, wherein said projection is provided so as to project in a direction where said optical sheet extends, and in a direction around the optical sheet.

7. The backlight according to claim 6, wherein a shape of said projection in planar view is a T-like shape.

8. The backlight according to claim 1, wherein a cutout is provided at a base of said projection.

9. The backlight according to claim 1, wherein said projection is provided in a region overlapping with a region where said pressing portion is provided in planar view.

10. A display device which comprises the backlight according to claim 1, and displays video, using light emitted by said backlight.
